(19) United States
(12) Patent Application Publication
(10) Pub. No.: US 2002/0114325 A1
(43) Pub. Date: Aug. 22, 2002

(54) Phoneline network integrated access device

(76) Inventors: Allan D. Dale, Haslett, MI (US); Daryl J. Chymyck, Lansing, MI (US); Thomas R. Bayerl, Williamston, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/788,155

(22) Filed: Feb. 16, 2001

(51) Int. Cl. H04L 12/66

(52) U.S. Cl. 370/355; 370/463; 370/465

(57) ABSTRACT

An integrated access device (IAD) provides a broadband communication link between a home phoneline networking alliance (HPNA) local area network (LAN) and an external network, to form a wide area network (WAN). The HPNA LAN includes a plurality of personal computers each coupled to a first building telephone line through an HPNA port. In one embodiment, the IAD includes an HPNA interface, a first processor, a memory subsystem and a wireless interface. The HPNA interface is coupled to the HPNA LAN and the first processor, which is coupled to the memory subsystem that is utilized for storing information. The wireless interface is also coupled to the first processor and provides a communication link between the IAD and the external network.

### BACKGROUND OF THE INVENTION

The present invention is generally directed to providing broadband services to a residence or business, and more particularly to providing broadband services to a residence or business that implements a home phoneline networking alliance (HPNA) local area network (LAN).

Many residences and businesses can benefit from the installation of a LAN when multiple personal computers (PCs) are utilized within a given residence or business. For example, a LAN generally allows all networked PCs to transfer files across the LAN, access a networked printer or networked hard disk drive (HDD) and can provide a single high-speed Internet connection, e.g., through a server. Traditionally, many businesses and residences that have desired to network a number of PCs have installed network interface cards (NICs) within each PC and connected the PCs with Ethernet cables to establish an Ethernet local area network (LAN). However, doing so has typically required that an Ethernet cable be installed during construction of the residence or business, or has required stringing the Ethernet cables behind various furniture and/or through dropped ceilings and/or raised floors such that the PCs could be connected through an Ethernet NIC, located in a peripheral component interconnect (PCI) slot of each PC.

Another drawback to implementing an Ethernet LAN is that it is difficult for a novice to configure. As such, designers have attempted other networking techniques for, at least, residential applications. For example, residential LANs have been implemented using a building's electrical wiring system, which has typically yielded a relatively slow and unreliable network. Various wireless local area networks (LANs) have also been implemented to allow a number of PCs to share an Internet connection and send files to another PC or printer. A typical wireless LAN is designed to connect as many as fifteen PCs at distances of up to one-hundred fifty feet and is implemented by providing a wireless interface in each PC. Typically, the wireless interface is provided as an add-in card (e.g., a PCI card) for desktop PCs and as a PC card for notebooks PCs. Data transfer speeds for such commercially available wireless networks are comparable to those of standard Ethernet wired 10 Mbps LANs. However, wireless networking equipment, that can achieve reasonable transfer rates, i.e., 10 Mbps, tends to be expensive and can be difficult to install and may not function through more than a few walls.

Today, many residences and small businesses are currently implementing a second generation home phoneline networking alliance (HPNA) local area network (LAN) that permits a network connection of up to 16 Mbps over an existing building telephone line, without interfering with normal use (i.e., an analog voice signal) of the telephone line. In a typical HPNA LAN, each PC is coupled to the building telephone line through an HPNA port, such as a HPNA card that plugs into a peripheral component interconnect (PCI) slot of the PC. Alternatively, HPNA connectivity can be achieved through an adapter, such as a universal serial bus (USB) adapter, which plugs into a USB port of each PC and an existing telephone jack of the residence or small business. In this manner, PCs so equipped can communicate with one another and can access a networked HDD or printer coupled to one of the PCs. In contrast to an Ethernet LAN, a HPNA LAN does not require a hub. That is, each PC simply connects to the nearest telephone jack through an HPNA port.

In residences that include a fast Internet connection, such as a digital subscriber line (DSL), cable or integrated services digital network (ISDN) modem, a HPNA LAN allows all networked PCs to share a single Internet connection. However, the single Internet connection has typically been facilitated through a dedicated PC (e.g., a server), which must be powered on at all times or awaken from a standby mode, upon receiving a request from a device connected to the LAN, in order for any PC to access the Internet.

In response to this perceived problem, a new kind of network device called a residential gateway has been designed. One such residential gateway incorporates a DSL modem and a port for connecting to a HPNA LAN. This residential gateway may include a USB port, an Ethernet connection, a firewall and browser software.

Further, commercially available integrated access devices (IADs) have provided Internet access and Ethernet LAN connectivity for businesses. For example, one such IAD has offered integrated services digital network basic-rate interface (ISDN-BRI) connectivity, two analog plain old telephone service (POTS) interfaces, eight 10Base-T ports and a 10Base-2 port, among other features. The ISDN-BRI interface provides high-speed wide area network (WAN) connectivity to an Internet service provider (ISP) or another Ethernet LAN. The multi-channel functionality of the ISDN-BRI interface supports analog and digital communication simultaneously, which reduces cost by eliminating the need for multiple analog phonelines. Another commercially available IAD includes two T1 ports, a V.35 port, a 10Base-T Ethernet port and an RS232 interface. This IAD simultaneously supports both voice and data services and can provide sixteen onboard foreign exchange station (FXS) ports with built-in ring generation, which provides time division multiplexing (TDM) based telephony services.

However, no commercially available integrated access device or residential gateway provides a wireless broadband communication link between a home phone networking alliance (HPNA) local area network (LAN) and an external network to form a wide area network (WAN). Additionally, no commercially available integrated access device provides a broadband communication link between a HPNA LAN and an external network to form a WAN, while simultaneously providing a plain old telephone service (POTS) interface.

### SUMMARY OF THE INVENTION

The present invention is directed to an integrated access device (IAD) for providing a broadband communication link between a home phoneline networking alliance (HPNA) local area network (LAN) and an external network to form a wide area network (WAN). The HPNA LAN includes a plurality of personal computers each coupled to a first building telephone line through an HPNA port. The IAD includes an HPNA interface, a first processor, a memory subsystem and a wireless interface. The HPNA interface is coupled to the HPNA LAN. The first processor is coupled to the HPNA interface and the memory subsystem, which is utilized for storing information. The wireless interface is coupled to the first processor and provides a communication link between the IAD and the external network.

In another embodiment, the IAD includes a plain old telephone service (POTS) interface coupled between the first processor and a second building telephone line. The second building telephone line provides POTS service to at least one POTS telephone.

These and other features, advantages and objects of the present invention will be further understood and appreciated by those skilled in the art by reference to the following specification, claims, and appended drawings.

### BRIEF DESCRIPTION OF THE DRAWINGS

In the drawings:

FIG. 1 is an electrical schematic in block diagram form of a communication system for providing a broadband communication link between a home phoneline networking alliance (HPNA) local area network (LAN) and an external network to form a wide area network (WAN); and

FIG. 2 is an electrical schematic in block diagram form of another communication system for providing a broadband communication link between a HPNA LAN and an external network to form a WAN.

### DETAILED DESCRIPTION OF PREFERRED EMBODIMENT(S)

The present invention is directed to customer premise equipment (CPE) that provides a broadband communication link between a home phoneline networking alliance (HPNA) local area network (LAN) and an external network, to form a wide area network (WAN). As utilized herein, the term ‘broadband’ includes transmissions in which a single medium (e.g., a tip and ring twisted wire pair) is utilized to carry several channels at one time. As mentioned above, a typical HPNA LAN includes a plurality of personal computers (PCs), which are coupled to a building telephone line (i.e., a tip and ring twisted wire pair) through a HPNA port, such as a commercially available HPNA interface card that plugs into a peripheral component interconnect (PCI) slot of a PC (e.g., a PCI Phoneline Card manufactured by Farallon Communications, Inc.).

Alternatively, the HPNA port can be provided by a commercially available universal serial bus (USB) adapter, configured to transfer information between a USB port of each PC and the building telephone line (e.g., a USB-to-Phoneline Adapter manufactured by Farallon Communications, Inc.). Further, the HPNA port can be provided by other techniques, such as a Firewire™ adapter, i.e., a IEEE 1394 adapter, or an Ethernet-to-phoneline adapter.

As discussed herein, an embodiment of the present invention is directed to an integrated access device (IAD) that provides a communication link between a HPNA LAN and an external network. The IAD includes an HPNA interface, a first processor, a memory subsystem and a wireless interface that includes a wireless modem. The HPNA interface couples the HPNA LAN to the first processor, which is also coupled to the wireless interface and provides a communication link between the IAD and the external network. In another embodiment, an IAD, which provides Internet access for the HPNA LAN, also includes a plain old telephone service (POTS) interface that provides POTS service for at least one POTS telephone. The IAD includes a communication interface, which is configured to include one of a wireless interface or a digital subscriber line (DSL) interface. The communication interface is coupled to a first processor, which provides a communication link between the HPNA LAN (including a first building telephone line) and the external network. The first processor also provides a communication link between the external network and the POTS interface, which provides POTS service to at least one POTS telephone, via a second building telephone line.

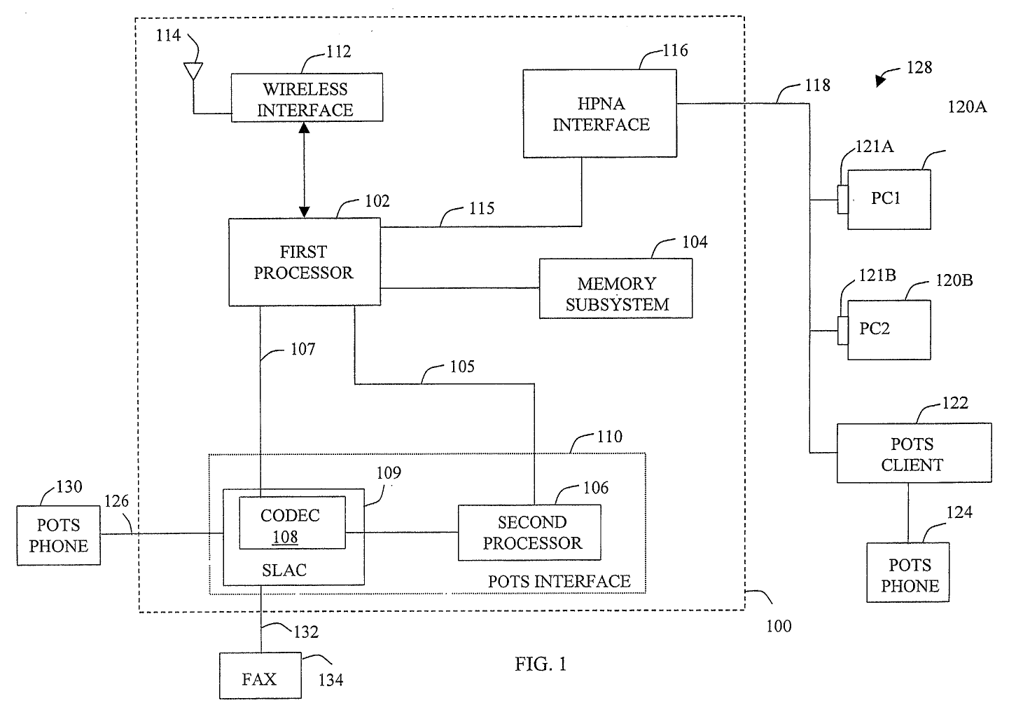

As shown in FIG. 1, an integrated access device (IAD) 100 provides a broadband communication link to a home phoneline networking alliance (HPNA) local area network (LAN) 128, which includes a plurality of PCs 120A and 120B and a POTS client 122 coupled to a first building telephone line 118. While only two PCs 120A and 120B are shown, it is contemplated that a greater number of PCs 120 can be implemented. The IAD 100 includes a first processor 102 that is coupled to a memory subsystem 104, a HPNA interface 116 and a plain old telephone service (POTS) interface 110.

The first processor 102, among other tasks, is programmed to coordinate communication between a wireless interface 112 (that includes a wireless modem) and the HPNA interface 116. The first processor also coordinates communication between the wireless interface 112 and the POTS interface 110. In coordinating communication, the first processor 102 performs packet processing, routing and management, among other functions. Preferably, the first processor 102 is coupled to the wireless interface 112 via a universal test and operations physical interface for ATM (UTOPIA) II port. Integrated circuitry for implementing a suitable wireless interface 112 is manufactured and made commercially available by Lucent Technologies Inc.

Communication between the external network (i.e., a wireless base station) and the IAD 100 is facilitated by an antenna 114, which is coupled to the wireless interface 112. The memory subsystem 104 includes an application appropriate amount of volatile memory (dynamic random access memory (DRAM)) and non-volatile memory (e.g., flash memory or electrically erasable programmable read-only memory (EEPROM)). The first processor 102 communicates with the HPNA LAN 128 through the HPNA interface 116. As used herein, the term ‘processor’ may include a general purpose processor, a microcontroller (i.e., an execution unit with memory, etc., integrated within a single integrated circuit) or a digital signal processor.

As mentioned above, the HPNA LAN 128 is formed by a first building telephone line 118, which is coupled to a plurality of PCs 120A and 120B, through a plurality of HPNA ports 121A and 121B, respectively. The HPNA ports 121A and 121B can be, for example, a universal serial bus (USB) adapter, a peripheral component interconnect (PCI) card or an IEEE 1394 adapter. Also coupled to the line 118 is a POTS client (i.e., a voice over Internet protocol (VOIP) converter) 122, which performs voice signal conversion (e.g., analog-to-digital/digital-to-analog conversion and coding/decoding) for a conventional POTS phone 124. In this manner, both digital voice signals and digital data signals can be carried on the first building telephone line 118. A suitable POTS client 122 can be implemented with integrated circuits manufactured and made commercially available by Advanced Micro Devices Inc.

In another embodiment, the POTS client 122 receives operating power from the IAD 100, via the building telephone line 118. This is advantageous in that an external power source is not required for the POTS client 122, which allows the client 122 to be directly plugged into only an existing telephone wall jack. Additionally, an Internet phone (not shown) can be directly coupled to the first building telephone line 118. Internet phones are commercially available through a number of manufactures, e.g., Intel and VocalTec, Ltd.

Preferably, any communication received by the IAD 100, through the wireless interface 112, is in the form of an asynchronous transfer mode (ATM) packet. The first processor 102 is configured to convert each ATM packet to a voice over Internet protocol (VoIP) packet, when the packet destination is the HPNA LAN 128 or the second processor 106. The first processor 102 is also programmed to perform call management functions. That is, each port 105, 107 and 115 is assigned a separate telephone number and the first processor 102 performs appropriate processing and routes a packet to the appropriate port, based on each packets associated telephone number.

When the received packet corresponds to a non-compressed digital voice signal destined for POTS phone 130, the signal is transferred directly to a coder/decoder (codec) 108, located within the POTS interface 110, on port 107. When the received packet corresponds to a compressed digital voice signal destined for POTS phone 130, the signal is transferred directly to the second processor 106, located within the POTS interface 110, on port 105. Preferably, the codec 108 is integrated within a subscriber line access controller (SLAC) 109. In addition to providing a codec for coding an analog voice signal or decoding a digital voice signal, the SLAC 109 provides ring generation and includes line protection circuitry, among other functions. A suitable SLAC is manufactured and made commercially available by Advanced Micro Devices Inc.

Preferably, the second processor 106, when implemented, is a digital signal processor (DSP) manufactured and made commercially available by Texas Instruments Inc. of Houston, Tex. (TMS320 family). The second processor 106 is configured to compress/decompress a digital voice signal that is transferred between the first processor 102 and a second building telephone line 126 and compress/decompress a data signal on a third building telephone line 132. When a digital voice signal is not compressed, the first processor 102 routes the digital voice signal directly to the codec 108, which performs decoding of the digital voice signal to be provided to the POTS telephone 130 and coding of an analog voice signal from the POTS telephone 130. As shown, the SLAC 109 is also coupled to the third building telephone line 132, for transferring data from/to a facsimile machine 134.

A suitable first processor 102 is manufactured and made commercially available by Motorola, Inc. (Part No. MPC8260). The MPC8260, is an integrated communication microprocessor, that is specifically designed for telecommunication and networking applications and includes a PowerPC™ core and a communications processor module (CPM). The MPC8260 includes two UTOPIA level-2 master/slave ports and three media independent interface (MII) interfaces. Another suitable first processor 102 is also manufactured and made commercially available by Motorola, Inc. of Schaumburg, Ill. (Part No. MPC855). The MPC855 is a communications microprocessor that also includes a PowerPC™ core and a CPM.

When the first processor 102 determines that an ATM packet is to be routed to the HPNA LAN 128, it translates the ATM packet to a VoIP packet. As stated above, the first processor 102, preferably, is also configured to perform call manager functions for multiple ports 107, 105 and 115, which are associated with separate phone numbers such that when a packet is received, processor 102 can determine where to route the received packet (that is, whether to route the information to the HPNA LAN 128 or to the POTS interface 110). When HPNA interface 116 receives a VoIP packet from the first processor 102, it translates the packet and provides the packet on the first building telephone line 118 for receipt by an addressed device (i.e., PC1 120A, PC2 120B or client 122).

In a preferred embodiment, the HPNA interface 116 includes a HW3000M home phoneline networking physical layer and a HW2000 home phoneline networking analog front end (AFE), both manufactured and made commercially available by Lucent Technologies. The HW2000 is designed to support all the front end transmit/receive options required for various HW3xxx controllers and physical products. The combination of the HW2000 and the HW3000M form a complete fully integrated turnkey solution designed to provide high-speed networking over existing residential telephone wiring. The HW2000 includes both transmit and receive variable gain amplifiers (VGAs), and an (A/D) analog-to-digital converter, a digital-to-analog (D/A) converter, a line driver, a crystal oscillator circuit and an anti-aliasing filter for the receive/transmit paths.

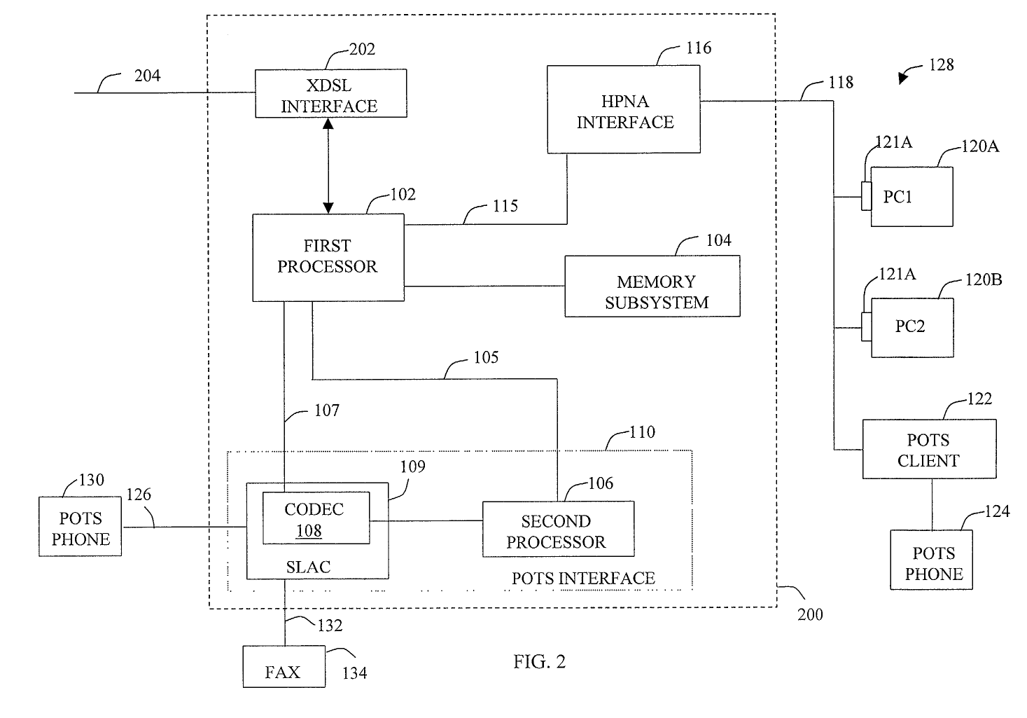

Turning to FIG. 2, an integrated access device 200, according to another embodiment of the present invention, is shown. In the embodiment of FIG. 2, items that are common to FIG. 1 have been labeled with the same reference numerals and their functionality is not further discussed herein. The primary difference between the IAD 200 of FIG. 2 and the IAD 100 of FIG. 1 is that the IAD 200 implements an ‘x’ digital subscriber line (xDSL) interface (that includes a DSL modem) 202. As used herein, the term ‘xDSL’ is utilized to collectively refer to all variations of DSL (e.g., ADSL, SDSL, VDSL, G.lite). Suitable integrated circuits for implementing a DSL interface are manufactured and made commercially available by GlobeSpan Technologies Inc.

The xDSL interface 202 preferably communicates, using asynchronous transfer mode (ATM) packets, with a digital subscriber line access multiplexer (DSLAM) located at a central office (CO). Packets received by the xDSL interface 202 are provided to the first processor 102, preferably, through a UTOPIA II interface. As described above, the first processor 102 determines the destination of a given packet and routes the packet to its destination. In this manner, the first processor 102, of FIG. 2, is configured to provide a communication link between a DSL 204, via the xDSL interface 202, and the HPNA LAN 128. The first processor is also configured to provide a communication link between the DSL line 204 and the POTS interface 110.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

What is claimed is:

1. An integrated access device (IAD) for providing a broadband communication link between a home phoneline networking alliance (HPNA) local area network (LAN) and an external network to form a wide area network (WAN), the HPNA LAN including a plurality of personal computers each coupled to a first building telephone line through an HPNA port, the IAD comprising:
an HPNA interface coupled to the HPNA LAN;
a first processor coupled to the HPNA interface;
a memory subsystem for storing information coupled to the first processor; and
a wireless interface coupled to the first processor, the wireless interface providing a communication link between the IAD and the external network.

2. The IAD of claim 1, further including:
a plain old telephone service (POTS) interface coupled between the first processor and a second building telephone line, the second building telephone line providing POTS service to at least one POTS telephone.

3. The IAD of claim 2, the POTS interface further including:
a second processor coupled to the first processor, wherein the second processor is configured to receive and decompress a compressed digital voice signal; and
a codec coupled to the second processor, wherein the codec is configured to receive the decompressed digital voice signal and provide an analog voice signal to the second building telephone line.

4. The IAD of claim 3, wherein the codec is also configured to provide a data signal to a third building telephone line.

5. The IAD of claim 3, wherein the codec is also configured to receive a non-compressed digital voice signal from the first processor and provide a corresponding analog voice signal to the second building telephone line.

6. The IAD of claim 3, wherein the second processor is a digital signal processor.

7. The IAD of claim 1, wherein the HPNA port is provided by a universal serial bus (USB) adapter configured to transfer information between a USB port of one of the personal computers and the first building telephone line.

8. The IAD of claim 3, wherein the HPNA port is provided by a peripheral component interconnect (PCI) card configured to transfer information between a PCI bus of one of the personal computers and the first building telephone line.

9. An integrated access device (IAD) for providing a broadband communication link between a home phoneline networking alliance (HPNA) local area network (LAN) and an external network to form a wide area network (WAN), the HPNA LAN including a plurality of personal computers each coupled to a first building telephone line through an HPNA port, the IAD comprising:
an HPNA interface coupled to the HPNA LAN;
a first processor coupled to the HPNA interface;
a memory subsystem for storing information coupled to the first processor;
a communication interface coupled to the first processor, the communication interface providing a communication link between the IAD and the external network, wherein the communication interface is configured to include one of a wireless interface and a digital subscriber line (DSL) interface; and
a plain old telephone service (POTS) interface coupled between the first processor and a second building telephone line, the second building telephone line providing POTS service to at least one POTS telephone.

10. The IAD of claim 9, the POTS interface further including:
a second processor coupled to the first processor, wherein the second processor is configured to receive and decompress a compressed digital voice signal; and
a codec coupled to the second processor, wherein the codec is configured to receive the decompressed digital voice signal and provide an analog voice signal to the second building telephone line.

11. The IAD of claim 10, wherein the codec is configured to provide data to a third building telephone line.

12. The IAD of claim 10, wherein the codec is also configured to receive a non-compressed digital voice signal from the first processor and provide a corresponding analog voice signal to the second building telephone line.

13. The IAD of claim 9, further including:
a plain old telephone service (POTS) client coupling a POTS telephone to the HPNA network, the POTS client configured to separate digital voice signals and digital data signals supplied on the first building telephone line and provide analog voice signals to the POTS telephone.

14. The IAD of claim 13, wherein the POTS client is powered by the IAD through the first building telephone line.

15. The IAD of claim 9, wherein the second processor is a digital signal processor.

16. The IAD of claim 9, wherein the HPNA port is provided by a universal serial bus (USB) adapter configured to transfer information between a USB port of one of the personal computers and the first building telephone line.

17. The IAD of claim 9, wherein the HPNA port is provided by a peripheral component interconnect (PCI) card configured to transfer information between a PCI bus of one of the personal computers and the first building telephone line.

18. A method for providing a broadband communication link between a home phoneline networking alliance (HPNA) local area network (LAN) and an external network to form a wide area network (WAN), the HPNA LAN including a plurality of personal computers each coupled to a first building telephone line through an HPNA port, the method comprising the steps of:
providing an HPNA interface coupled to the HPNA LAN;
providing a first processor coupled to the HPNA interface;
providing a memory subsystem for storing information coupled to the first processor; and
providing a communication interface coupled to the first processor, the communication interface providing a communication link between the IAD and the external network, wherein the communication interface is configured to include one of a wireless interface including a wireless modem and a digital subscriber line (DSL) interface including a DSL modem; and
providing a plain old telephone service (POTS) interface coupled between the first processor and a second building telephone line, the second building telephone line providing POTS service to at least one POTS telephone.

19. The method of claim 18, further including the steps of:
providing a second processor coupled to the first processor, wherein the second processor is configured to receive and decompress a compressed digital voice signal; and
providing a codec coupled to the second processor, wherein the codec is configured to receive the decompressed digital voice signal and provide an analog voice signal to the second building telephone line.

20. The method of claim 19, wherein the codec is configured to provide digital data to a third building telephone line.

21. The method of claim 19, wherein the codec is also configured to receive a non-compressed digital voice signal from the first processor and provide a corresponding analog voice signal to the second building telephone line.

22. The method of claim 18, further including the step of:
providing a plain old telephone service (POTS) client coupling a POTS telephone to the HPNA network, the POTS client configured to separate a digital voice signal and digital data signal supplied on the first building telephone line and provide an analog voice signal to the POTS telephone.

23. The method of claim 22, wherein the POTS client is powered by the IAD through the first building telephone line.

24. The method of claim 18, wherein the second processor is a digital signal processor.

25. The method of claim 18, wherein the HPNA port is provided by a universal serial bus (USB) adapter configured to transfer information between a USB port of one of the personal computers and the first building telephone line.

26. The method of claim 18, wherein the HPNA port is provided by a peripheral component interconnect (PCI) card configured to transfer information between a PCI bus of one of the personal computers and the first building telephone line.
